(19) United States
(12) Patent Application Publication
(10) Pub. No.: US 2020/0400216 A1
(43) Pub. Date: Dec. 24, 2020

(54) TRIPLE-CLUTCH TRANSMISSION

(71) Applicant: CNH Industrial America LLC, New Holland, PA (US)

(72) Inventors: Enrico Sedoni, Modena (IT); Garth H. Bulgrien, Ephrata, PA (US); Jie Tu, Hinsdale, IL (US)

(73) Assignee: CNH Industrial America LLC, New Holland, PA (US)

(21) Appl. No.: 16/447,345

(22) Filed: Jun. 20, 2019

(51) Int. Cl. F16H 3/093

(52) U.S. Cl. CPC F16H 3/093; F16H 2003/0818

(57) ABSTRACT

A transmission for a work vehicle with an engine and a drivetrain. The transmission includes a plurality of shafts, a plurality of gears arranged on the plurality of shafts, and a plurality of clutches arranged on the plurality of shafts. The plurality of clutches includes a first clutch, a second clutch, and a third clutch. The transmission provides for full-power shifting throughout at least 24 speeds with only a single clutch swap required for each shift.

### BACKGROUND OF THE INVENTION

The present invention pertains to work vehicles and, more specifically, to a transmission for a work vehicle.

A work vehicle, such as a large truck or agricultural tractor, generally includes a chassis, an engine, a transmission, a drivetrain, and accompanying wheels for the two or more axles which may be operably coupled to the drivetrain. The engine may be an internal combustion engine, such as a diesel engine, which provides a motive force. The transmission may transmit the motive force, in various gear ratios, to the wheels through the drivetrain which may selectively couple the drive axles in order to operate the vehicle in one or more tractive, i.e., drive, configurations, such as a 4×4, 6×2, 6×4, 6×6, 8×4, 8×8, or 10×8 drive configuration. For example, the work vehicle may include front and rear driven axles. Thereby, the work vehicle may accomplish various tasks, e.g. towing a load or implement, by adjusting the motive force provided to the wheels or tracks by way of the transmission and drivetrain.

A typical transmission may generally include a housing, multiple gear shafts, gears arranged on the gear shafts, and clutches. The gear shafts may include an input shaft coupled with the engine, a counter shaft, an output shaft coupled with the drivetrain, and layshafts with drive gears arranged thereon. The clutches may be arranged on the gear shafts and may selectively engage to create a desired torque path from the input shaft, through one or more gears of the layshafts, and to the output shaft to provide motive force to the wheels.

A dual clutch transmission (DCT) may generally include two clutches and a plurality of synchronizers which permit the pre-selection of the next gear, either higher or lower, which is not currently in the torque path. Then, when synchronizers for the current and subsequent gears are both engaged, the switch between speeds may occur simply by switching the dual clutches. Thus, power shift capability is provided while using a low number of clutches, thus minimizing clutch drag to provide high efficiency; and the power shifts are accomplished with a single clutch swap. However, some dual clutch transmissions may not allow skip shifting, or skipping one speed, e.g. shifting directly from speed one to speed three, in order to rapidly increase or decrease the speed of the work vehicle, and may not provide a sufficiently wide range of speeds without using multiple synchronized ranges that do not provide powershift capability through all speeds.

What is needed in the art is a cost-effective transmission that provides a large range of speeds with powershift capability through all speeds and ability to skip shift.

### SUMMARY OF THE INVENTION

In one exemplary embodiment formed in accordance with the present invention, there is provided a triple clutch transmission that generally includes four gear shafts with drive gears arranged thereon, three drive clutches, and multiple synchronizers for preselecting one or more drive gears. The triple clutch transmission allows for a full powershift capability in a DCT-type transmission.

In another exemplary embodiment formed in accordance with the present invention, there is provided a transmission for a work vehicle with an engine and a drivetrain. The transmission includes a plurality of shafts including an input shaft configured for connecting to and receiving power from the engine, an output shaft configured for connecting to the drivetrain, a first shaft, a second shaft, a third shaft, a fourth shaft operably connected to the first shaft, the second shaft, the third shaft, and the output shaft, and a fifth shaft operably connected to the first shaft, the second shaft, and the third shaft. The transmission also includes a plurality of gears arranged on the plurality of shafts and a plurality of clutches arranged on the plurality of shafts and providing for 12 speeds driving a two-speed range resulting in at least 24 speeds. The plurality of clutches includes a first clutch configured for selectively drivingly connecting the first shaft with the input shaft, a second clutch configured for drivingly connecting the second shaft with the input shaft, and a third clutch configured for drivingly connecting the third shaft with the input shaft.

In yet another exemplary embodiment formed in accordance with the present invention, there is provided a work vehicle including a chassis, an engine supported by the chassis, a drivetrain operably connected to the chassis, and a transmission operably connected to the engine. The transmission includes a plurality of shafts including an input shaft operably connected to and receiving power from the engine, an output shaft operably connected to the drivetrain, a first shaft, a second shaft, a third shaft, a fourth shaft operably connected to the first shaft, the second shaft, the third shaft, and the output shaft, and a fifth shaft operably connected to the first shaft, the second shaft, and the third shaft. The transmission also includes a plurality of gears arranged on the plurality of shafts and a plurality of clutches arranged on the plurality of shafts and providing for 12 speeds driving a two-speed range resulting in at least 24 speeds. The plurality of clutches includes a first clutch configured for drivingly connecting the first shaft with the input shaft, a second clutch configured for drivingly connecting the second shaft with the input shaft, and a third clutch configured for drivingly connecting the third shaft with the input shaft.

In yet another exemplary embodiment formed in accordance with the present invention, there is provided a method of operating a work vehicle. The method includes an initial step of providing a transmission for the work vehicle. The transmission includes a plurality of shafts including an input shaft operably connected to and receiving power from the engine, an output shaft operably connected to the drivetrain, a first shaft, a second shaft, a third shaft, a fourth shaft operably connected to the first shaft, the second shaft, the third shaft, and the output shaft, and a fifth shaft operably connected to the first shaft, the second shaft, and the third shaft. The transmission also includes a plurality of gears arranged on the plurality of shafts, a plurality of clutches arranged on the plurality of shafts and providing for 12 speeds driving a two-speed range resulting in at least 24 speeds, the plurality of clutches comprising a first clutch configured for drivingly connecting the first shaft with the input shaft, a second clutch configured for drivingly connecting the second shaft with the input shaft, and a third clutch configured for drivingly connecting the third shaft with the input shaft. The method also includes the steps of engaging one of the first clutch, the second clutch, and the third clutch and skip shifting from one gear of the plurality of gears to another gear of the plurality of gears.

One possible advantage of the exemplary embodiment of the transmission of the present invention is that the transmission allows for all powershifts to occur with a single clutch swap.

Another possible advantage of the exemplary embodiment of the transmission of the present invention is that the transmission provides for skip shifting to bypass the next gear in sequence in order to rapidly upshift or downshift the work vehicle.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a side view of an exemplary embodiment of a work vehicle comprising an engine and a 25×25 triple clutch transmission providing 25 forward speeds and 25 reverse speeds, according to an exemplary embodiment of the present invention;

FIG. 2 illustrates the triple-clutch transmission of the work vehicle of FIG. 1;

FIG. 3 illustrates the engagement sequence of the transmission of FIG. 2;

FIG. 4 illustrates another embodiment of the transmission of the work vehicle in form of a 25×25 split range transmission;

FIG. 5 illustrates another embodiment of the transmission of the work vehicle in the form of a 24×24 split range transmission;

FIG. 6 illustrates another embodiment of the transmission of the work vehicle in the form of a 24×24 split range transmission with a smaller low range output gear of the work vehicle; and

FIG. 7 illustrates the engagement sequence of the transmission of FIG. 5 or the transmission of FIG. 6.

### DETAILED DESCRIPTION OF THE INVENTION

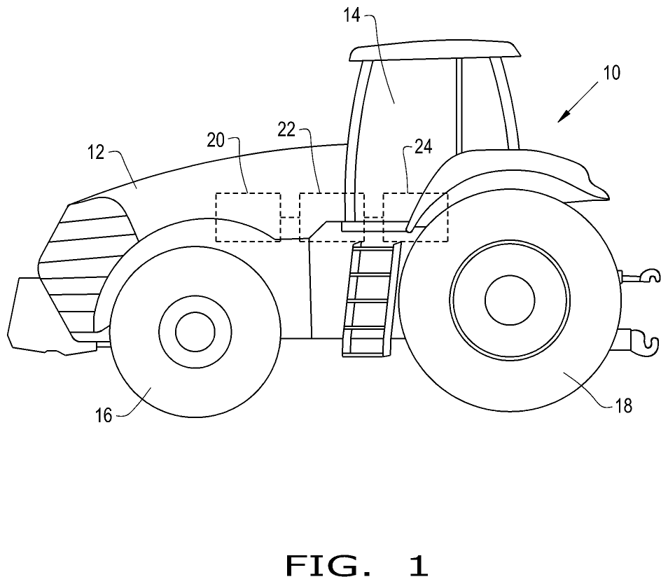

Referring now to the drawings, and more particularly to FIG. 1, there is shown a work vehicle 10 which generally includes a frame 12, a cabin 14 for the operator, wheels 16, 18 supporting the frame 12, an engine 20, a triple-clutch transmission (TCT) 22 operably coupled to the engine 20, and a drivetrain 24 operably interconnected between the transmission 22 and the wheels 16, 18. The work vehicle 10 may be any desired vehicle, such as a loader, tractor, grader, backhoe, forklift, or any other agricultural vehicle. As shown, the work vehicle 10 is in the form of an agricultural tractor 10, such as a Case IH Magnum™ series tractor.

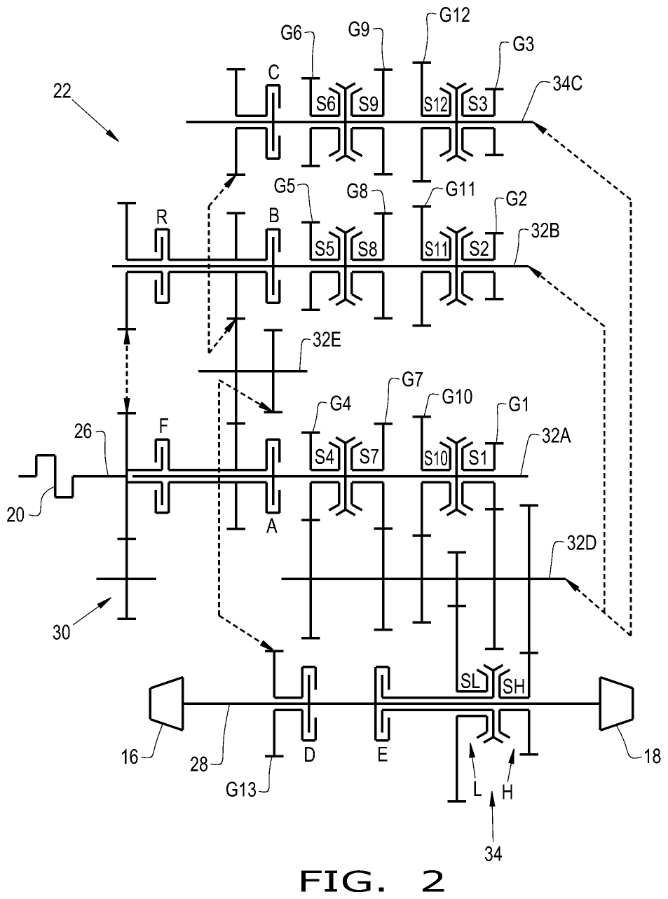

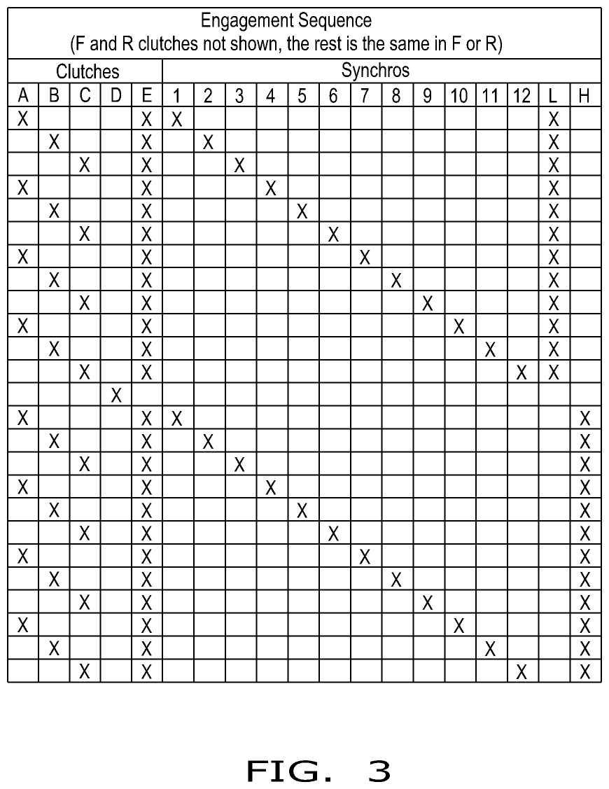

Referring now to FIGS. 2-3, there is shown a schematic of the transmission 22 that has a two-speed range, 12 speeds, and an additional jump speed providing for 25×25 speeds (FIG. 2) and the engagement sequence of the transmission 22 (FIG. 3). The transmission 22 allows for full-power shifting, e.g. switching gear ratios with a single clutch A-C swap, and also provides for skip shifting, for example shifting directly from speed one to speed three. The transmission 22 generally includes multiple shafts 26, 28, 30, 32A-32E, gears including drive gears G1-G12, clutches F, R and A-E, and synchronizers S1-S12, SL, SH. The transmission 22 may include a range section 34 with a low range L and a high range H. It should be appreciated that the transmission 22 may have any desired number of shafts 26, 28, 30, 32A-32E, gears G1-G12, clutches F, R, A-E, and paired synchronizers, i.e., synchros S1-S12, SL, SH. For example, the transmission 22 may include ten shafts, twenty-eight gears, seven clutches, and seven paired synchronizers.

The transmission 22 may include an input shaft 26 operably connected to and receiving power from the engine 20, and an output shaft 28 that is operably connected to and drives a load, such as the wheels 16, 18, by way of the drivetrain 24. The input shaft 26 may be operably coupled to a power take off (PTO) shaft 30. The transmission 22 may also include five layshafts 32A-32E for transferring power from the engine 22 to the output shaft 28. The first shaft 32A, second shaft 32B, and third shaft 32C may each be respectively operably connected to the fourth shaft 32D and the fifth shaft 32E via one or more gears (unnumbered). The fourth shaft 32D and the fifth shaft 32E may each be respectively operably connected to the output shaft 28 via one or more gears (unnumbered). It should be appreciated that the fifth shaft 32E may be directly connected to the input shaft 26.

Each shaft 32A-32C may have one or more drive gears, such as drive gears G1-G12, arranged thereon. As shown, the first shaft 32A includes paired drive gears G4, G7 and G10, G1, the second shaft 32B includes paired drive gears G5, G8 and G11, G2, the third shaft 32C includes paired drive gears G6, G9 and G12, G3, and the output shaft 28 includes bypass drive gear G13 arranged thereon which allows for shifting between the low and high ranges L, H. Each drive gear G1-G12 pair may have an accompanying paired synchronizer S1-S12. As can be appreciated, one or more gears (unnumbered) may engage in a meshed connection with one another to operably connect one or more of the shafts 26, 28, 32A-32E. As shown in FIG. 2, the phantom arrows indicate which shafts 32A-32E, e.g. the gears thereof, operably mesh with one another.

The gears G1-G12 may be arranged on the shafts 32A-32D in any desired configuration. Each gear G1-G12 may respectively have any desired size and number of teeth. The gears G1-G12 may also have any desired ratio in shifting between sequential gears G1-G12. The gears G1-G12 may have any desired size difference to yield any desired percent step increase or decrease between the gears G1-G12, for example a change in step of approximately 12-14%, plus or minus 2%.

The transmission 22 may include a first clutch A arranged on the first shaft 32A for drivingly connecting the first shaft 32A with the input shaft 26, a second clutch B arranged on the second shaft 32B for drivingly connecting the second shaft 32B with the input shaft 26, and a third clutch C arranged on the third shaft 32C for drivingly connecting the third shaft 32C with the input shaft 26. The transmission 22 may also include a fourth clutch D arranged on the output shaft 28 and a fifth clutch E associated with the range section 34. The fourth clutch D is in the form of a jump clutch which is configured for selectively coupling the output shaft 28 with the fifth shaft 32E. The jump clutch D provides for an additional torque bypass path, i.e., through the jump clutch D and drive gear G13, that provides a jump speed, in which shifting between the low and high ranges L, H may occur. The transmission 22 therefore provides for skip shifting throughout the speeds 1-25, except for shifting directly between the twelfth and fourteenth speeds. It should be appreciated that the transmission 22 may also include a forward clutch F and a reverse clutch R. The forward and reverse clutches F, R may respectively be arranged directly on the first and second shafts 32A, 32B or on a designated shaft which may be operably coupled with the first and second shafts 32A, 32B. It should be appreciated that the clutches A-E may be arranged on any desired shaft 32A-32E. For instance, one or more clutches may be arranged on the fifth shaft 32E and one or more gears may also be provided therewith.

The clutches F, R, A-E may be selectively actuated to achieve the 25×25 speeds, i.e., gear ratios 1 through 25 in forward, and additional gear ratios 1 through 25 in reverse, between the input shaft 26 and the output shaft 28. Each clutch F, R, A-E may be configured to selectively couple a gear to a shaft or selectively couple a shaft to another shaft. The clutches F, R, A-E may be in the form of any suitable clutch(es), including one or more dry clutches, wet clutches, single/multi plate clutches, pneumatic and hydraulic clutches, electromagnetic clutches, or any combination thereof.

The range section 34 may be arranged on the output shaft 28. The range section 34 provides the two-speed range with low and high ranges L, H selected via the paired range synchronizer SL, SH. The range section 34 may also have a fifth clutch E in order to engage paired synchronizer SL, SH to output shaft 28. The range section 34 may also include range gears GL, GH respectively associated with the low and high ranges L, H.

Referring now specifically to FIG. 3, there is shown an engagement, i.e., shift, sequence for the transmission 22, which includes 12 speeds from the triple-clutch arrangement in each of the two ranges and the jump speed from the fourth clutch D arranged on the output shaft 28, thus resulting in 25 speeds. Here, the drive gears G1-G12 and the jump speed, via drive gear G13, are illustrated in successive rows, with each speed achievable via a power flow path through the transmission 22. The desired speed may be achieved by engaging the appropriate clutch A, B, C, D, E and synchronizer S1-S12 and range L, H, as indicated with an “X”. For instance, to operate the work vehicle 10 in the first speed, the clutches A, E, and L, and synchronizer S1 may be engaged. The five clutches A-E and the gears G1-G12 are arranged such that three clutches of the five clutches A-E may be engaged to complete a power flow or ratio path, and when transitioning to the next speed two of the three clutches from the previous drive gear remain engaged when shifting between adjacent speeds, e.g. from the first speed to the second speed, or when skip shifting, e.g. from the first speed to the third speed. Thus, a single-clutch swap enables sequential power-shifting from one speed to the next. Accordingly, the comfort and/or efficiency associated with operation of the work vehicle 10 may be enhanced. It should be appreciated that any clutch A-E may be pre-filled during switching from one clutch A-E to another. It should also be appreciated that any synchronizer S1-S12 may be preselected, e.g. engaged but not within the torque path, to assure an efficient switching from one drive gear G1-G12 to another. Furthermore, it should be appreciated that the clutches A-E may be at least partially, simultaneously engaged during a switching procedure in which two or more of the clutches A-E are actively being swapped.

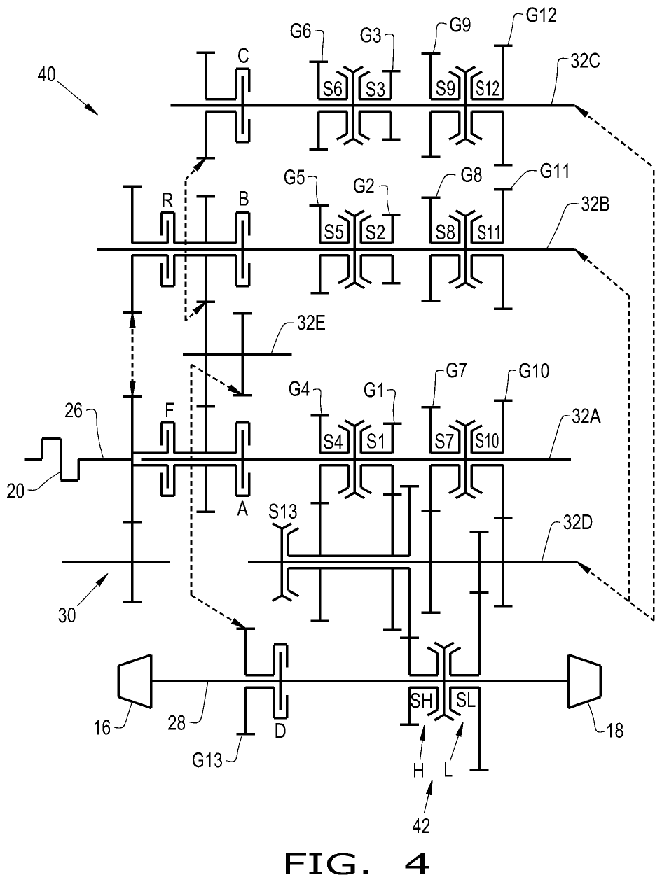

Referring now to FIG. 4, there is shown a schematic of another embodiment of a transmission 40 for the work vehicle 10. The transmission 40 may be substantially similar to the transmission 22 except that the transmission 40 has a range section 42 that is split into two parts and an additional synchronizer S13 is arranged on the fourth shaft 32D for connecting the two parts of the range section 42 together. Thereby, the transmission 40 provides the jump speed through clutch D and drive gear G13, as discussed above, which results in 25×25 speeds. The engagement sequence may be substantially similar to the engagement sequence of the transmission 22, except for the operation of the synchronizer S13 selectively engaging the two separate parts of the range section 42.

The range section 42 is arranged on the output shaft 28 for providing the two-speed range with a low range L and a high range R and a paired synchronizer SL, SH. The low and high ranges L, H are divided into separate parts and are respectively connected with the synchronizer S13 and the fourth shaft 32D. The synchronizer S13 may then selectively transfer power through the low range L or the high range H. Thereby, the synchronizer S13 can be disconnected to reduce the inertia to be accelerated while shifting between the low and high ranges L, H during driving in the jump speed. It should be appreciated that the transmission 40 may have any desired number of shafts 26, 28, 30, 32A-32E, gears G1-G12, clutches F, R, A-E, and synchronizers S1-S13, SL, SH. For example, the transmission 40 may include ten shafts, twenty-eight gears, six clutches, and seven paired synchronizers and a half synchronizer.

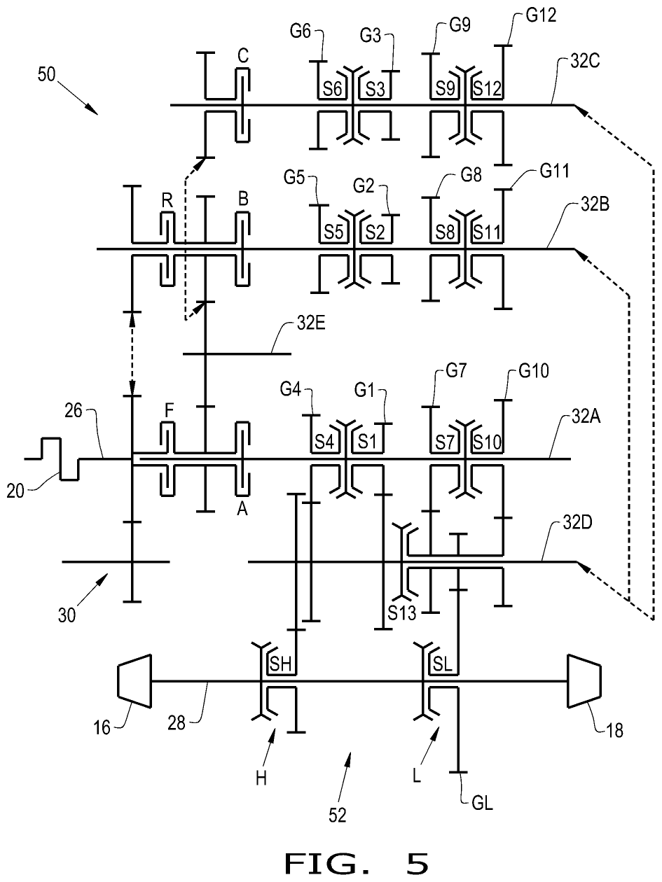

Referring now to FIG. 5, there is shown a schematic of another embodiment of a transmission 50 for the work vehicle 10. The transmission 50 allows for full-power shifting and skip shifting; yet, the transmission 50 does not use a jump speed, which thereby provides for 12 speeds driving in a two-speed range resulting in 24×24 speeds. Hence, the transmission 50 differs from the transmission 22, 40 because the transmission 50 does not include clutch D; thereby, the transmission 50 does not provide a jump speed. The transmission 50 generally includes multiple shafts 26, 28, 30, 32A-32E, gears including drive gears G1-G12, clutches F, R and A-C, a range section 52, and synchronizers S1-S13, SL, SH. It should be appreciated that the transmission 50 may have any desired number of shafts 26, 28, 30, 32A-32E, gears G1-G12, clutches F, R, A-C, and synchronizers S1-S13, SL, SH. For example, the transmission 50 may include ten shafts, twenty-six gears, five clutches, and seven paired synchronizers and a half synchronizer.

The shafts 32A-32E may be arranged such that the fourth shaft 32D is operably connected to the first, second, and third shafts 32A, 32B, 32C via one or more gears (unnumbered). The fifth shaft 32E may be operably connected to the first, second, and third shafts 32A, 32B, 32C via one or more gears (unnumbered). The fifth shaft 32E may not be directly connected to the output shaft 28 by way of the jump clutch D as in the transmission 22. The first shaft 32A may have the paired drive gears G1, G4 and G7, G10 arranged thereon, the second shaft 32B may have the paired drive gears G2, G5 and G8, G11 arranged thereon, and the third shaft 32C may have the paired drive gears G3, G6 and G9, G12 arranged thereon.

The range section 52 of the transmission 50 is a split range section 52 with an independent low range L having its own designated synchronizer SL and a high range H with its own designated synchronizer SH. The range section 52 is arranged on the output shaft 28 for providing the two-speed range L, H. The additional synchronizer S13 is arranged on the fourth shaft 32D and is operably connected to the range section 52. The synchronizer S13 may selectively engage any of the drive gears G1-G12 with the low and high ranges L, H. For example, the synchronizer S13 may engage the drive gears G1-G6 with the low range L and the drive gears G7-G12 with the high range H. Together, the split range section 52 with its synchronizers SL, SH and the additional synchronizer S13 may reduce the inertia to be accelerated while shifting between the low and high ranges L, H. In addition, when synchronizer S13 is disengaged, synchronizers SL and SH can both be engaged, thus allowing shifts to be made between speeds 12 in low range and 1 in high range, or speeds 11 in low range and 1 in high range, or speeds 12 in low range and 2 in high range, without shifting synchronizers SL or SH.

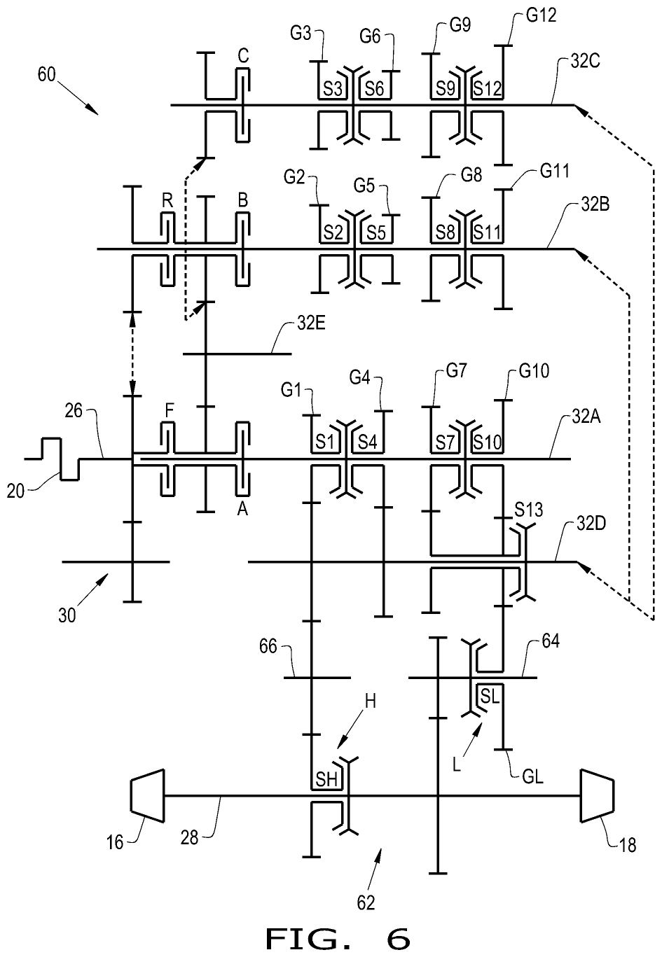

Referring now to FIG. 6, there is shown a schematic of another embodiment of a transmission 60 for the work vehicle 10. The transmission 60 may be substantially similar to the transmission 50 except that the transmission 60 may include a different split range section 62. Furthermore, the transmission 60 may include gears which are smaller than the gears of the transmission 50. For example, the low range gear GL of the transmission 60 may be smaller than the low range gear GL on the output shaft 28 of the transmission 50.

The split range section 62 may include a low range L having a low range shaft idler 64 and a synchronizer SL as well as a high range H having a high range shaft idler 66 and a synchronizer SH. The shaft idlers 64, 66 are respectively operably connected to the fourth shaft 32D. The configuration of the split range section 62 allows for another gear reduction in between the fourth shaft 32D and the output shaft 28. The low range shaft idler 64 may be operably connected in between the fourth shaft 32D and the output shaft 28 via one or more gears (unnumbered). The low range synchronizer SL may be arranged on the low range idler shaft 64, which may reduce the inertia to be accelerated while engaging synchronizer L. The high range shaft idler 66 may be operably connected in between the fourth shaft 32D and the output shaft 28. The high range synchronizer SH may be arranged on the output shaft 28.

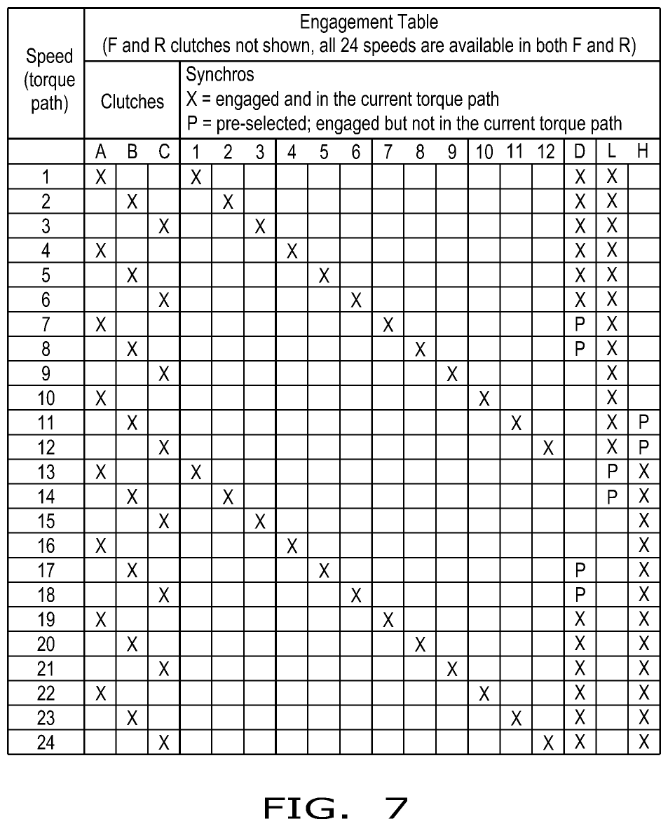

Referring now to FIG. 7, there is shown an engagement, i.e., shift, sequence for the 24×24 speed transmissions 50, 60. Each transmission 50, 60 includes 12 speeds from the triple-clutch arrangement A-C and a two-speed range section 52, 62 which results in 24 speeds in the forward or reverse direction. The drive gears G1-G12 are illustrated in successive rows, with each speed 1-24 being achievable via a designated power flow path by selecting a desired clutch A-C, low range L or high range H, and synchronizer S1-S13, which is designated with an “X”. The arrangement of the clutches A-C, the drive gears G1-G12 on the shafts 32A-32C, and the synchronizer S13 provides for skip shifting between speeds 1-24 and between the low and high ranges L, H.

The work vehicle 10 may also include an electronic control unit (ECU) to control the operation of the engine 20 and/or the transmission 22. The ECU may be in the form of any desired controller or processor which includes a memory. The controller may control the operation of the transmission 22 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the controller described herein is implemented in software code or instructions which are tangibly stored on a tangible computer readable medium. The controller loads the software code or instructions via a direct interface with the computer readable medium or via a wired and/or wireless network. Upon loading and executing such software code or instructions by the controller, the controller may perform any of the functionality of the controller described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. A transmission for a work vehicle with an engine and a drivetrain, comprising:
a plurality of shafts, comprising:
an input shaft configured for connecting to and receiving power from the engine;
an output shaft configured for connecting to the drivetrain;
a first shaft;
a second shaft;
a third shaft;
a fourth shaft operably connected to the first shaft, the second shaft, the third shaft, and the output shaft; and
a fifth shaft operably connected to the first shaft, the second shaft, and the third shaft;
a plurality of gears arranged on the plurality of shafts; and
a plurality of clutches arranged on the plurality of shafts and providing for 12 speeds driving a two-speed range resulting in at least 24 speeds, the plurality of clutches comprising:
a first clutch configured for selectively drivingly connecting the first shaft with the input shaft;
a second clutch configured for selectively drivingly connecting the second shaft with the input shaft; and
a third clutch configured for selectively drivingly connecting the third shaft with the input shaft.

2. The transmission of claim 1, wherein the plurality of shafts, gears, and clutches provide for full-power shifting and skip shifting from one gear of the plurality of gears to another gear of the plurality of gears.

3. The transmission of claim 1, further comprising a fourth clutch and a bypass gear, the fourth clutch is in the form of a jump clutch which is configured for selectively coupling the output shaft with the fifth shaft, the jump clutch providing for a jump speed in addition to the 12 speeds driving the two-speed range resulting in 25 speeds.

4. The transmission of claim 3, wherein the jump clutch and the bypass gear provide for a bypass path through the jump clutch.

5. The transmission of claim 3, further comprising a range section arranged on the output shaft for providing the two-speed range and a fifth clutch arranged on the output shaft, the range section includes a low range and a high range and the fifth clutch is configured for selectively engaging one of the low range and high range.

6. The transmission of claim 3, further comprising a range section arranged on the output shaft for providing the two-speed range and a synchronizer arranged on the fourth shaft and operably connected to the range section, the range section includes a low range and a high range which are divided into separate parts such that the synchronizer is configured for selectively connecting the separate parts.

7. The transmission of claim 1, further comprising a range section arranged on the output shaft for providing the two-speed range and a synchronizer arranged on the fourth shaft and operably connected to the range section which provides for 12 speeds driving the two-speed range resulting in 24 speeds.

8. The transmission of claim 7, wherein the fifth shaft is not directly connected to the output shaft.

9. The transmission of claim 7, wherein the range section further comprises a low range, a low range shaft idler operably connected to the fourth shaft, a high range, and a high range shaft idler operably connected to the fourth shaft.

10. A work vehicle, comprising:
a chassis;
an engine supported by the chassis;
a drivetrain operably connected to the chassis;
a transmission operably connected to the engine, the transmission comprising:
a plurality of shafts, comprising:
an input shaft operably connected to and receiving power from the engine;
an output shaft operably connected to the drivetrain;
a first shaft;
a second shaft;
a third shaft;
a fourth shaft operably connected to the first shaft, the second shaft, the third shaft, and the output shaft; and
a fifth shaft operably connected to the first shaft, the second shaft, and the third shaft;
a plurality of gears arranged on the plurality of shafts; and
a plurality of clutches arranged on the plurality of shafts and providing for 12 speeds driving a two-speed range resulting in at least 24 speeds, the plurality of clutches comprising:
a first clutch configured for selectively coupling the first shaft with the input shaft;
a second clutch configured for selectively coupling the second shaft with the countershaft; and
a third clutch configured for selectively coupling the third shaft with the fifth shaft.

11. The work vehicle of claim 10, wherein the plurality of shafts, gears, and clutches provide for full-power shifting and skip shifting from one gear of the plurality of gears to another gear of the plurality of gears.

12. The work vehicle of claim 10, further comprising a fourth clutch and a bypass gear, the fourth clutch is in the form of a jump clutch which is configured for selectively coupling the output shaft with the fifth shaft, the jump clutch providing for a jump speed in addition to the 12 speeds driving the two-speed range resulting in 25 speeds.

13. The work vehicle of claim 12, wherein the jump clutch and the bypass gear provide for a bypass path through the jump clutch.

14. The work vehicle of claim 12, further comprising a range section arranged on the output shaft for providing the two-speed range and a fifth clutch arranged on the output shaft, the range section includes a low range and a high range and the fifth clutch is configured for selectively engaging one of the low range and high range.

15. The work vehicle of claim 12, further comprising a range section arranged on the output shaft for providing the two-speed range and a synchronizer arranged on the fourth shaft and operably connected to the range section, the range section includes a low range and a high range which are divided into separate parts such that the synchronizer is configured for selectively transferring a power through one of the low range and high range.

16. The work vehicle of claim 10, further comprising a range section arranged on the output shaft for providing the two-speed range and a synchronizer arranged on the fourth shaft and operably connected to the range section which provides for 12 speeds driving the two-speed range resulting in 24 speeds.

17. The work vehicle of claim 16, wherein the fifth shaft is not directly connected to the output shaft.

18. The work vehicle of claim 16, wherein the range section further comprises a low range, a low range shaft idler operably connected to the fourth shaft, a high range, and a high range shaft idler operably connected to the fourth shaft.

19. A method of operating a work vehicle having an engine and a drivetrain, comprising:
providing a transmission for the work vehicle, the transmission comprising a plurality of shafts, comprising an input shaft operably connected to and receiving power from the engine, an output shaft operably connected to the drivetrain, a first shaft, a second shaft, a third shaft, a fourth shaft operably connected to the first shaft, the second shaft, the third shaft, and the output shaft, and a fifth shaft operably connected to the first shaft, the second shaft, and the third shaft, a plurality of gears arranged on the plurality of shafts, a plurality of clutches arranged on the plurality of shafts and providing for 12 speeds driving a two-speed range resulting in at least 24 speeds, the plurality of clutches comprising a first clutch configured for drivingly connecting the first shaft with the input shaft, a second clutch configured for drivingly connecting the second shaft with the input shaft, and a third clutch configured for drivingly connecting the third shaft with the input shaft;
engaging one of the first clutch, the second clutch, and the third clutch; and
skip shifting from one gear of the plurality of gears to another gear of the plurality of gears.

20. The method of claim 19, wherein the transmission further comprises a fourth clutch and a bypass gear, the fourth clutch is in the form of a jump clutch which is configured for selectively coupling the output shaft with the fifth shaft, the jump clutch providing for a jump speed in addition to the 12 speeds driving the two-speed range resulting in 25 speeds.
